(19) United States
(12) Patent Application Publication
(10) Pub. No.: US 2007/0052414 A1
(43) Pub. Date: Mar. 8, 2007

(54) Monitoring platform

(75) Inventors: Reiner T. Venegas, Murfreesboro, TN (US); William Maurice Carl, La Vergne, TN (US)

Correspondence Address: ADVANTIA LAW GROUP, 9035 SOUTH 1300 EAST, SUITE 200, SANDY, UT, 84094, US

(73) Assignee: Venegas Innovative Products, LLC

(21) Appl. No.: 11/222,181

(22) Filed: Sep. 7, 2005

(51) Int. Cl. G02B 6/30; G01V 3/00

(52) U.S. Cl. 324/303; 62/55.5; 248/550; 385/49

(57) ABSTRACT

There is a monitoring platform for providing a sensory feed to a musician. There is a base, an electronics module, a reflective coating, an electrical outlet, and a tactile transducer. The base includes a ramping member, an upper surface member, a storage member, first and second clamshell members hingedly coupled, a handle, a coupling member or latch, and a vent. There is also an amplifier, a high pass filter, a headset and port, a daisy-chain signal port, and modular construction such that multiple platforms may be joined to form a single surface.

### BACKGROUND OF THE INVENTION

1. Field of the Invention

The present invention relates to monitoring platforms, specifically to combination musician platforms.

2. Description of the Related Art

Live musical performances demand real-time adjustments in tempo, pitch, volume, etc. from musicians. Accordingly, the quality of such a musical performance is strongly influenced by sound feedback heard by the musicians. However, the sound environment on stage is substantially different from that out in an audience. Musicians are typically very close to powerful sound sources, such as drums. For example, a drummer may only be able to hear the drums, as sound pressure level from the drums may drown out any other sounds. Therefore, an ideal sound on stage will typically not produce an appropriate sound for the audience. Therefore, attempts have been made to provide useful sound feedback to stage musicians. Such is called stage monitoring and is typically managed by a sound engineer.

current method of monitoring onstage requires a knowledgeable technician/engineer to tune and ring monitors that feed sound mixes to the musicians. Also, the engineer typically needs to make adjustments to present an accurate sound and to prevent feedback in the monitors. Further, each musician may need a special sound mix and such needs may change from song to song. Accomplishing such requires a great deal of encumbering and expensive equipment as well as substantial expertise and effort on the part of the sound engineer.

Even with an established stage monitoring system, there are additional problems. For example, instruments producing low frequency sound ideally should be felt by the musician as well as heard. In particular, proper playing of a bass requires that the bass player feel the notes being played in order to deliver the proper effects. However, when using large monitors on stage, providing sufficient sound levels to the bass player tends to cause escalating volume needs among other musicians, raising the sound pressure levels on stage to damaging levels. This also forces the sound engineer to devote considerable effort and time to managing the escalation and leaves all parties somewhat dissatisfied with the entire performance.

Alternatively, a sound engineer may equip performers with In Ear Monitoring (IEM) wherein each musician is substantially isolated from all sounds except those coming from the IEM system. However, this system carries its own problems. Where in-ear monitors are used, the musicians are isolated and lose a feel for the overall ambience of the sound. Also, in-ear monitors cannot provide the lower frequencies produced by instruments such as bass guitars and kick drums.

What is needed is a monitoring system method, apparatus, and/or device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available monitoring platforms. Accordingly, the present invention has been developed to provide a combination monitoring platform.

In one embodiment, there is a monitoring platform for providing a sensory feed to a musician. The monitoring platform may include a base, an electronics module, and/or a tactile transducer. The electronics module may be coupled to the base. The tactile transducer may be in oscillatory communication with the base and/or in signal communication with the electronics module.

The electronics module may be enclosed within the base. Also, the electronics module may include an amplifier and/or a volume adjuster. The base may include first and second clamshell members each hingedly coupled to the other, and/or a handle coupled to the first clamshell member. The base may include a hole configured to receive a stand. There may also be a headset electrically coupleable to the electronics module and/or a headset volume adjuster.

The base may include a ramping member including a first edge defining an exterior edge of the monitoring platform and a second edge higher than the first edge. The base may include an upper surface member substantially planar and substantially orthogonal to a direction of gravity when in use. The base may include a storage member coextensive with the upper surface member, extending higher than the upper surface member, and enclosing the electronics module.

The monitoring platform may further include a reflective coating disposed on the ramping member, first and second clamshell members each hingedly coupled to the other, a handle coupled to the first clamshell member, a coupling member disposed on at least one of the first and second clamshell members and configured to couple the first and second clamshell members when the monitoring platform is in a storage mode, a vent through at least one of the first and second clamshell members, and/or an electrical outlet electrically coupled to the electronics module and accessible to a user when the monitoring platform is in a deployed mode. There may also be an upper surface member having a top surface substantially planar and substantially orthogonal to a direction of gravity when in use. Additionally, there may be a storage member disposed on the top surface of the upper surface member and enclosing the electronics module.

In another embodiment, there is a system for providing a sensory feed to a musician. The system may include a base module, an electronics module configured to receive an electrical signal coupled to the base module, and first and second transducer modules coupled to the base module and in signal communication with the electronics module, wherein the first transducer module produces a vibratory signal through the base module between about 20 Hz to about 800 Hz and the second transducer module produces an audible vibratory signal. The base module may include a plurality of support ridges.

The electronics module may include an amplifier and/or a volume adjuster. The base member may include a ramping member. The electronics module may include an electrical outlet and/or a daisy-chain port. The base module may be removably coupleable to a second base module, wherein each of top surfaces of the base module and the second base module are substantially coplanar and coextensive. The second transducer module may include a support rod coupled to a top surface of the base module and/or a monitor supported by the support rod. The first transducer module may include a high pass filter or subsonic filter restricting vibrations lower than about 20 Hz.

In another embodiment, there may be a monitoring platform for providing a sensory feed to a musician. The monitoring platform may include a base that may include a ramping member including a first edge defining an exterior edge of the monitoring platform and a second edge higher than the first edge, an upper surface member substantially planar and substantially orthogonal to a direction of gravity when in use, and a storage member coextensive with the upper surface member, extending higher than the upper surface member, and enclosing the electronics module. There may also be included first and second clamshell members each hingedly coupled to the other, a handle coupled to the first clamshell member, a coupling member disposed on at least one of the first and second clamshell members and configured to couple the first and second clamshell members when the monitoring platform is in a storage mode, and/or a vent through at least one of the first and second clamshell members.

The embodiment may include an electronics module coupled to the base, a reflective coating disposed on the ramping member, an electrical outlet electrically coupled to the electronics module and accessible to a user when the monitoring platform is in a deployed mode, and/or a tactile transducer in oscillatory communication with the base and in electrical communication with the electronics module.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a front perspective view of a monitoring platform according to one embodiment of the invention;

FIG. 2 illustrates a bottom plan view of a monitoring platform according to one embodiment of the invention;

FIG. 3 illustrates a front plan view of a monitoring platform according to one embodiment of the invention;

FIG. 4 illustrates a front plan view of a monitoring platform in a partially folded mode according to one embodiment of the invention;

FIG. 5 illustrates a perspective view of a monitoring platform in a storage mode according to one embodiment of the invention;

FIG. 6 illustrates a perspective view of a monitoring platform in a storage mode according to one embodiment of the invention;

FIG. 7 illustrates a front perspective view of a monitoring platform including a pedal board according to one embodiment of the invention; and

FIG. 8 illustrates a rear perspective view of a monitoring platform according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

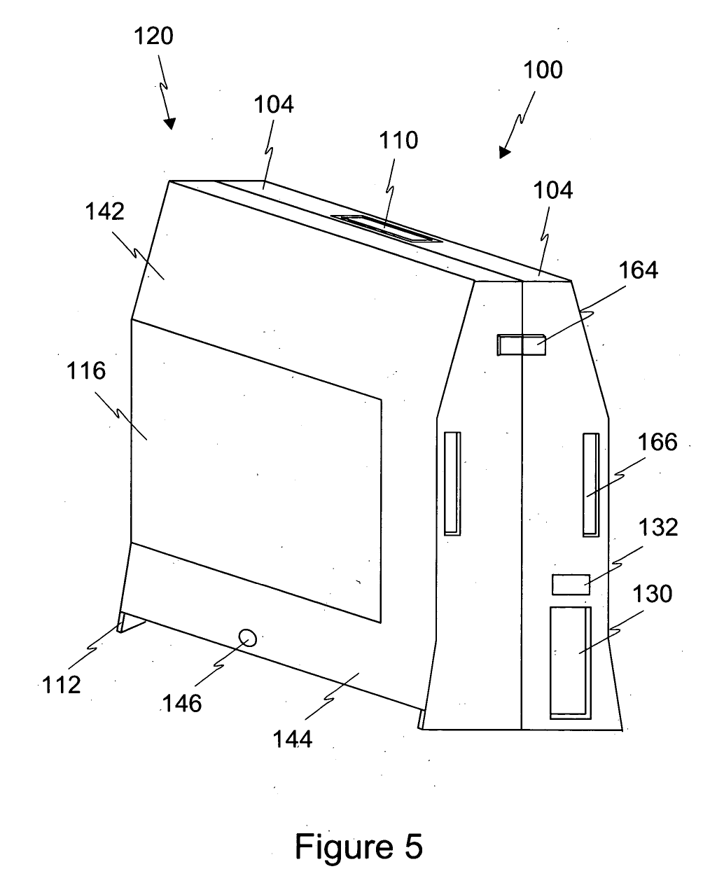

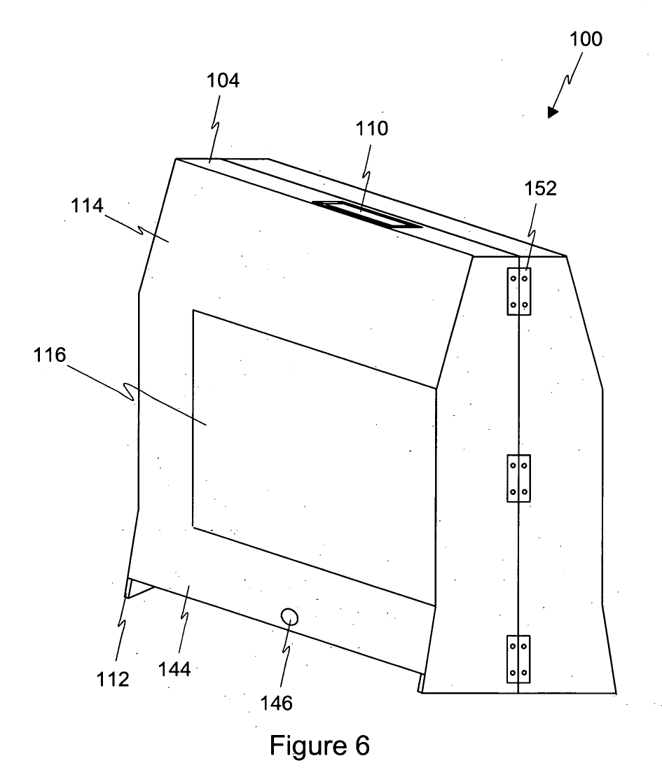

FIGS. -1-6 illustrate a monitoring platform according to one embodiment of the invention. The terms “front,” “rear,” “left,” and “right” are used in the specification from the point of view of a musician facing the device and facing an audience. Accordingly, the directions are reversed from the point of view of an audience. For example, a portion of the monitoring platform visible to such a musician may be a “front portion” and a portion obscured by the front portion may be a “back portion.” Further, when the monitoring platform 100 is in a carrying mode (see FIGS. 5 and 6) the terms top and bottom may be used relative to a position of the monitoring platform 100 with the handle 110 at the top and the feet 112 at the bottom. As illustrated, the handle 110 is at a front, or front surface 104. Various illustrated items are described as follows.

There is illustrated a monitoring platform 100 for providing a sensory feed to a musician. The illustrated monitoring platform 100 includes a base, housing, or support member 120, an electronics module 130 coupled to the base 120, and a pair of tactile transducers, vibratory transducer modules, or vibration modules 140 in oscillatory communication with the base 120 and in electrical communication with the electronics module 130.

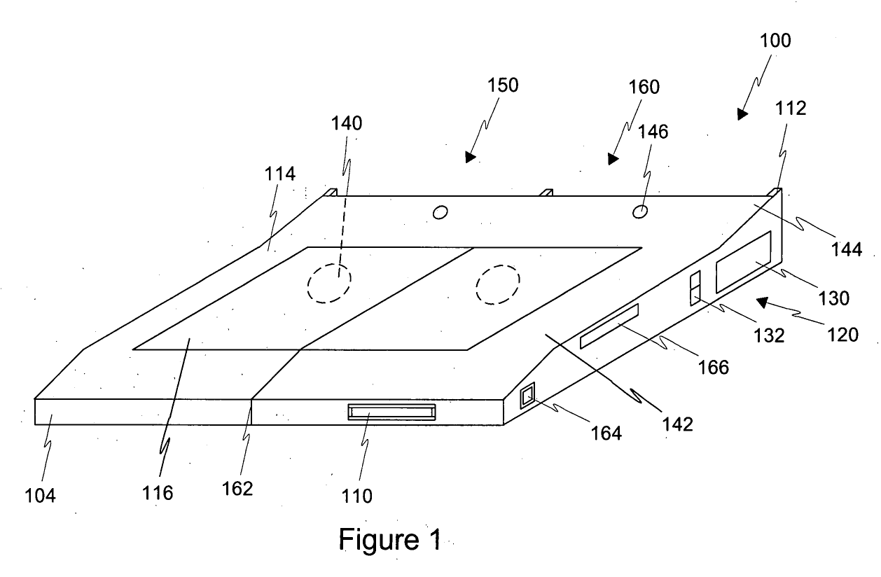

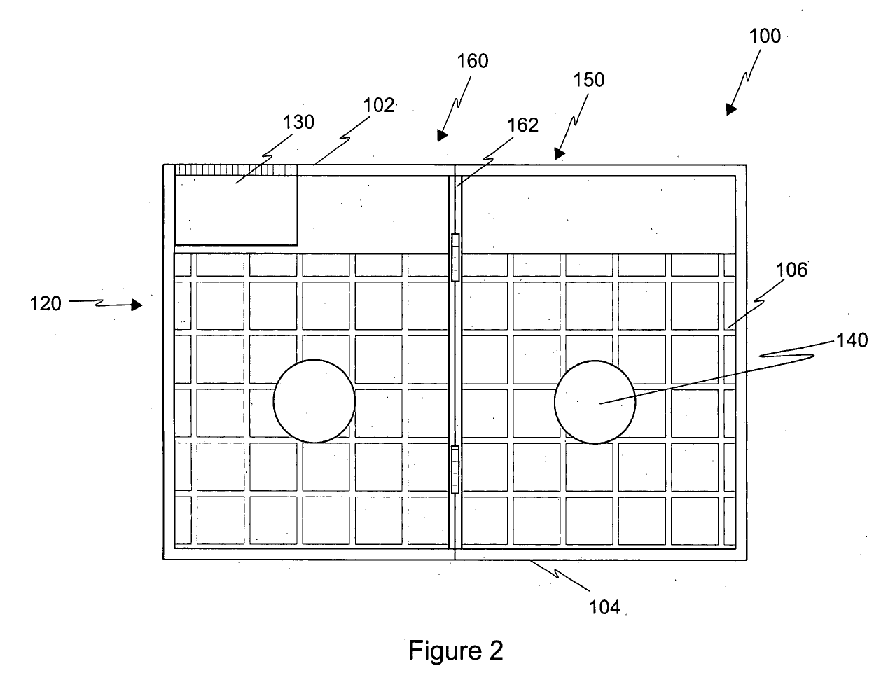

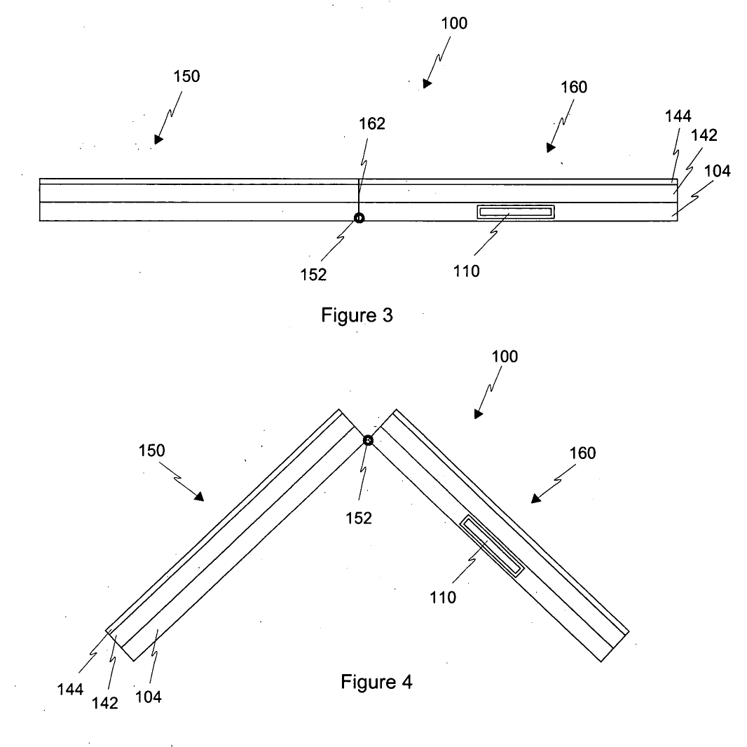

Also illustrated, is a pair of clamshell portions or members including a first, second, or left clamshell portion or member 150 and a second, first, or right clamshell portion or member 160. The clamshell members 150 and 160 are preferably hingedly coupled together by one or more hinges 152 such that the clamshell members 150 and 160 may rotate about an axis to a platform mode (see FIG. 1) or a carrying case mode (see FIGS. 5 and 6). The clamshell members 150 and 160 may be substantially symmetrical. The clamshell members 150 and 160 may meet at a substantially linear central interface 162 that may be a centrally disposed boundary between the clamshell members 150 and 160 wherein side faces of the clamshell members 150 and 160 may be adjacent and/or pressed together.

On each clamshell member 150 and 160 there is shown an upper surface, or upper surface member 114 having a non-slip and/or non-skid surface 116 that may be but is not limited to a layer of roughly textured material. The upper surface 114 may include a substantially horizontal portion configured to support at least a portion of a musician or musical instrument. Preferably, the upper surface 114 is a flat planar member orthogonal to gravity such that a musician may stand thereon without having to compensate balance.

Additionally, there is shown a ramping member 142 and a storage member, stabilizing member, or obscuring member 144 on each of the clamshell portions 150 and 160. The ramping-member 142 may function to assist a musician in mounting and/or dismounting from the monitoring platform 100. The ramping member 142 illustrated presents a ramped profile at the front of the monitoring platform 100. The ramping member 142 may include a reflective portion, such as but not limited to a strip of reflective tape configured to increase visibility of the ramping member. The illustrated storage member 144 presents a ramped profile going towards the back of the monitoring platform 100. The storage member 144 may serve to provide storage at a back 102 of the monitoring platform 100. The storage member 144 may function to hide details of the monitoring platform 100 from an audience. The storage member 144 may serve to widen the back 102 of the monitoring platform 100 thereby enhancing stability of the monitoring platform 100 when in the carrying case mode (see FIGS. 5 and 6). The storage member 144 may store one or more poles. The storage member 144 may store one or more cables, such as but not limited to power cables. There may be a power cable (not shown) for transferring power to the monitoring platform 100. In one non-limiting example, a power cable may be a 15 foot power cable.

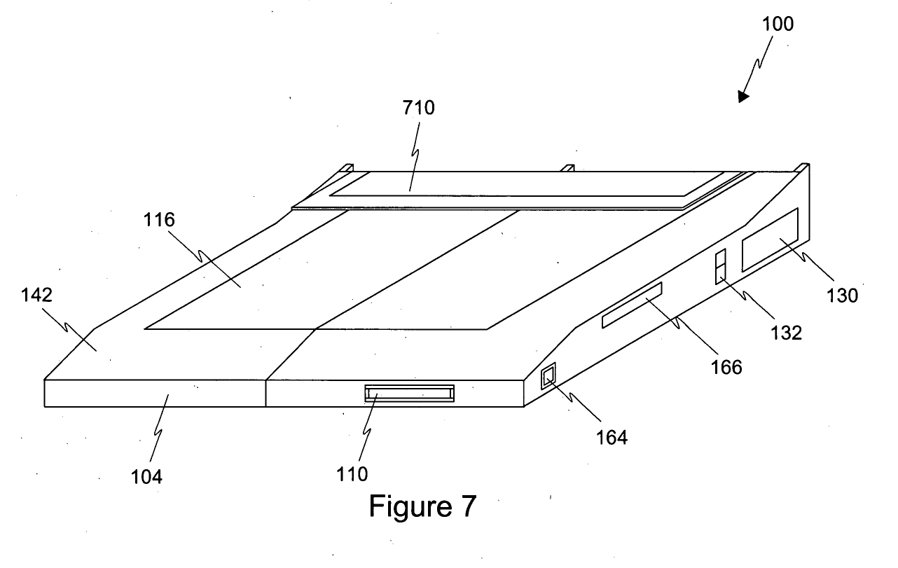

Through the storage member 144 there is illustrated a receiving member, hole, or post hole 146 on each clamshell portion 150 and 160, adjacent a back 102 of the platform and configured to receive an attachment, such as but not limited to a monitor stand, a music stand, a rod, and a pedal board (see FIG. 7). The hole 146 may be electronically coupled to the electronics module 130. As a non-limiting example, the hole may include an audio port coupled to the electronics module such that a monitor stand may be coupled thereto and an audio signal from the electronics module 130 may be fed to a speaker atop the monitor stand. A hole 146 may be threaded and/or may receive stands such as but not limited to lighting stands. There may be a plurality of holes 146 that may be positioned on various faces of the monitoring platform 100 in various locations.

On a front face or front surface 104 there is illustrated a handle 110 that may be a recessed handle that may be used to grip and/or carry the monitoring platform 100 especially while in the carrying case mode (see FIGS. 5 and 6). The handle is preferably coupled to a single clamshell member either 150 and/or 160 at a front surface 104 such that when the monitoring platform 100 is in a carrying mode the handle will be similar to a suitcase handle.

Further shown, is a latch, hang latch, or coupling device 164 configured to couple the clamshell members 150 and 160 together when the clamshell members 150 and 160 are in a carrying case mode (see FIGS. 5 and 6). There may be a pair of interlocking coupling devices 164 that may be clips, belts, ties, buckles, latches, hooks, and any other coupling devices known in the art.

Still further illustrated, there are vents, apertures, thermal transfer devices, or air transfer devices 166 disposed along a side of the monitoring platform 100. The vents 166 may be configured to help prevent a buildup of too much heat within the monitoring platform 100. Also, the vents 166 may be configured to permit sound to escape from the monitoring platform 100 thereby enhancing a resonant aspect of the monitoring platform 100.

There is also shown a set of electrical ports 132 that may include electrical outlets and/or the face of an electronics module 130. The electrical outlets are configured to provide electricity to devices plugged therein. The electrical outlets may be resetably fused to protect devices attached thereto. The electronics module 130 may include a plurality of devices, components, modules, instruments, controls, etc., such as but not limited to a main input XLR ¼″ combo connector, a headphone output ¼″, a throughput ¼″, a power output 9 VDC (such as for a pedal board), a tactile volume/level control, a headphone volume control, a 110 VAC input, an output for a tactile transducer, an electrical outlet, an amplifier, signal processor/processing, digital signal processor/processing, a compressor, a limiter, an equalizer, and an amplifier output. Non-limiting examples of an amplifier include Classes AB, H, and D and may include a variable and/or fixed crossover that may be built into the amplifier.

Also, the electronics module 130 may include and/or may be coupled to dampeners such as but not limited to foam, elastomer, springs, and rubber. There may be a vibration controller such as but not limited to a foot pedal, volume knob, and foot roller. It is preferred that volume controls be readily accessible to a musician using the monitoring platform without having to leave or cease using, even momentarily, the monitoring platform 100. The electronics module 130 may be controllable via a wireless controller that may be carried on a belt of a musician. The electronics module 130 may include a tuner. The electronics module 130 may include a wireless transmitter and/or receiver such as such necessary to operate a wireless headphone that may operate via methods and devices such as but not limited to the 2.4 Gigahertz range, UHF, VHF, and/or Bluetooth. The electronics module 130 may include a heat sink and/or a vent that may be located anywhere on the monitoring platform 100 and may be thermally coupled to the electronics module 130. The electronics module 130 may include an outboard unit. The electronics module 130 may be configured to receive a signal from another device. In one non-limiting example, an electronics module 130 is configured to receive an AUX feed from a board, such as but not limited to a FOH board or a monitoring board.

Within the monitoring platform 100 there are shown reinforcements 106 that are reinforcement fins 106 coupled to an underside of the upper surface 114, storage member 144, and ramping member 142. The reinforcements 106 may be configured to aid in reducing a weight of the platform, providing internal venting, reducing use of materials, increasing vibration transmission, and providing strength to the monitoring platform 100.

Outlined as dotted lines, there are tactile transducers 140 coupled to an underside of the upper surface 114. Non-limiting examples of transducers include those made by organizations known under the trade names or sold under the trade names of Aura Bass Shaker™ by AuraSound, Inc. at 11839 East Smith Avenue in Santa Fe Springs Calif., Bass Shaker Pro, Crowson Audio, and Clark Synthesis Tactile Sound™ at 8020 Southpark Circle Suite 600, Littleton Colo. There may be shielding, such as but not limited to copper plating shielding, that may reduce EMF transfer.

There is also shown a set of stabilizers, feet, or ridges 112 coupled to a back face 102 of the monitoring platform 100. The feet 112 may enhance stability of the monitoring platform when the platform is in a carrying case mode (see FIGS. 5 and 6). The feet 112 may protect the monitoring platform 100 (especially the electronics module 130) from jarring. The feet 112 may be of a flexible material that may absorb shock, impulses, and/or jarring, such as but not limited to rubber, plastic, and foam.

Moving to FIG. 7, there is shown a front perspective view of a monitoring platform including a pedal board according to one embodiment of the invention. The monitoring platform 100 illustrated is in a platform mode, having left and right clamshell members 150 and 160 open. There is a pedal board 710 attached to a top surface of the monitoring platform 100 adjacent a back 102 of the monitoring platform 100. The pedal board 710 may be coupled to one or more holes (not shown) in the monitoring platform 100 and may be coupled through such holes to the electronics module 130.

In operation, a user may stand on the monitoring platform 100 and/or may touch the monitoring platform 100. Information may be received and/or generated by the monitoring platform 100 and/or the user. Such information may include, but is not limited to, musical information, volume information, mixing information, and status information. Information may be generated and/or controlled by the user manipulating the pedal board 710. In particular, a user may be enabled by the pedal board to control an operation of the electronics module. As a non-limiting example, a user may be able to control an intensity of a feedback, such as but not limited to a vibratory feedback provided by a tactile transducer (not shown).

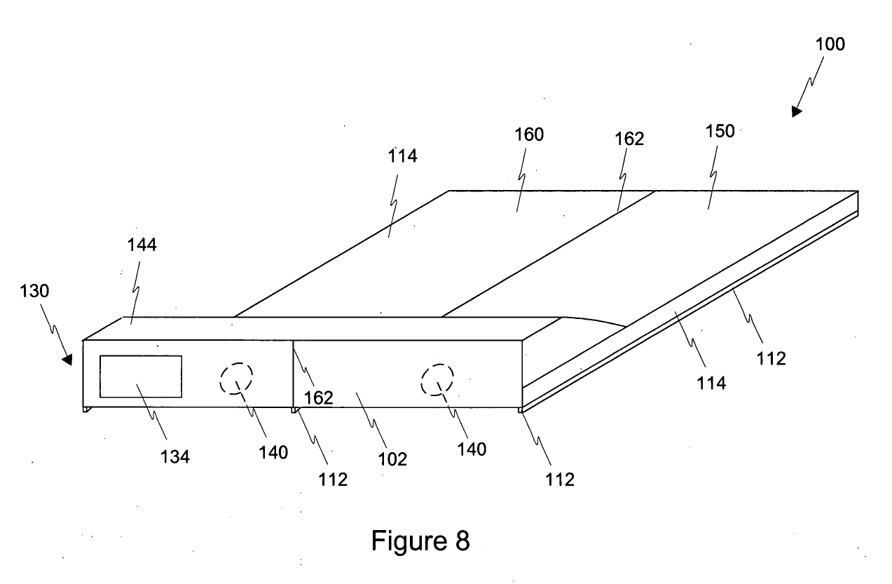

Finally, FIG. 8 illustrates a rear perspective view of a monitoring platform according to one embodiment of the invention. There is illustrated a monitoring platform 100 for providing a sensory feed to a musician. The illustrated monitoring platform 100 includes a base, housing, or support member 120, an electronics module 130 coupled to the base 120, and a pair of tactile transducers 140 in oscillatory communication with the base 120 and in electrical communication with the electronics module 130.

There is also illustrated a pair of clamshell portions or members including a first, second, or left clamshell portion or member 150 and a second, first, or right clamshell portion or member 160. The clamshell members 150 and 160 are preferably hingedly coupled together by one or more hinges (not shown) such that the clamshell members 150 and 160 may rotate about an axis to a platform mode (see FIG. 1) or a carrying case mode (not shown). The clamshell members 150 and 160 may be substantially symmetrical. The clamshell members 150 and 160 may met at a substantially linear central interface 162 that may be a centrally disposed boundary between the clamshell members 150 and 160 wherein side faces of the clamshell members 150 and 160 may be adjacent and/or pressed together.

On each clamshell portion 150 and 160 there is shown an upper surface, or upper surface member 114 having a substantially horizontal portion configured to support at least a portion of a musician or musical instrument. Preferably, the upper surface 114 is a flat planar member orthogonal to gravity such that a musician may stand thereon without having to compensate balance. The clamshell members 150 and 160 may each be substantially solid planar members that may comprise materials such as wood, particle board, metal, ceramic, plastics, polymers, resins, composites, etc.

There is also shown a storage member, stabilizing member, or obscuring member 144 on each of the clamshell portions 150 and 160. A storage member 144 may be on a back side 102 of the monitoring platform 100. The illustrated storage member 144 presents a ramped profile going towards the back 102 of the monitoring platform 100. The storage member 144 may serve to provide storage at a back 102 of the monitoring platform 100. The storage member 144 may function to hide details of the monitoring platform 100 from an audience. The storage member 144 may serve to widen the back 102 of the monitoring platform 100 thereby enhancing stability of the monitoring platform 100 when in a folded, or carrying case mode. The storage member 144 may store one or more poles. The storage member 144 may store one or more cables, such as but not limited to power cables. There may be a power cable (not shown) for transferring power to the monitoring platform 100. In one non-limiting example, a power cable may be a 15 foot power cable. The storage member 144 may house an electronics module 130 that may include a heat sink 134.

There is also shown tactile transducers 140 internal the storage member 144 and in vibratory communication with the upper surface 114. Non-limiting examples of transducers include those made by organizations known under the trade names or sold under the trade names of Aura Bass Shaker™ by AuraSound, Inc. at 11839 East Smith Avenue in Santa Fe Springs Calif., Bass Shaker Pro, Crowson Audio, and Clark Synthesis Tactile Sound™ at 8020 Southpark Circle Suite 600, Littleton Colo. There may be shielding, such as but not limited to copper plating shielding, that may reduce EMF transfer.

There is also shown a set of stabilizers, feet, or ridges 112 coupled to a bottom of the monitoring platform 100. The feet 112 may enhance stability of the monitoring platform when the platform is in a platform mode. The feet 112 may protect the monitoring platform 100 (especially the electronics module 130) from jarring. The feet 112 may be of a flexible material that may absorb shock, impulses, and/or jarring, such as but not limited to rubber, plastic, and foam. The feet 112 may be thin strips of material extending along a length of a clamshell member 150 and/or 160.

In operation, a user may stand on a monitoring platform 100. The monitoring platform 100 may receive a signal, such as but not limited to, a musical signal from an AUX channel of a board. The monitoring platform 100, through the electronics module 130, may filter a portion of the signal that may correlate to a particular frequency range. The electronics module 130 may filter out frequencies lower than about 20 Hz. The tactile transducers 140 may be configured to not play below a frequency of about 20 Hz. The tactile transducers 140 may be given signal information from the electronics module 130 to play between about 20 Hz and about 800 Hz.

Further, a user may be enabled to attach one or more peripheral devices to the monitoring platform 100 and/or the electronics module 130. Non-limiting examples include music stands, pedal boards, additional monitoring platforms, monitor stands, and monitors. Additionally, there may be remote devices in communication with the electronics module 130. As a non-limiting example, there may be a wireless device that may control one or more aspects of the electronics modules, such as toggling on/off, adjusting volume, channel selection, etc.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the figures illustrate a single platform, a plurality of platforms may be tiled together to form a larger platform.

In one embodiment, a platform is a raised platform approximately 4 inches high having transducers located directly underneath where a user would naturally put their feet. Advantageously, there would be a direct transfer of vibration from the transducers through the platform to the user.

It is also envisioned that a platform may be constructed to any size desired. A platform may be constructed of any material, including but not limited to wood, plastic, metal, composite, ceramic, fibers, plastics, and polymers.

It is expected that there could be numerous variations of the design of this invention. An example is that the monitoring platform may be a single unit that may be purchased as a single unit. In another example, the monitoring platform serves as its own carrying case. In yet another example, the monitoring platform provides a full range of signal to a musician. A monitoring platform may be water-proof or water-resistant. A monitoring platform may be sized sufficient to accommodate a bass player that may need to move around. There may be included a tactile transducer with a high impedance load, that uses low amounts of power, and/or that is not bulky. A unit may be a portable, lightweight, and/or easily transportable unit. A unit may be usable immediately after merely unfolding and plugging in power and/or an audio feed. A monitoring platform may be configured for use in a studio, including for example vibration isolation portions or isolation footings coupled to a bottom of the monitoring platform configured to reduce vibratory transfer from the monitoring platform to the floor upon which the platform rests.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. A monitoring platform for providing a sensory feed to a musician, comprising:
a base configured to be in physical contact with a musician;
an electronics module coupled to the base and configured to receive a first signal and to transmit a second signal; and
a vibration module in vibratory communication with the base and in signal communication with the electronics module sufficient to receive the second signal.

2. The monitoring platform of claim 1, wherein the electronics module comprises enclosed within the base.

3. The monitoring platform of claim 1, wherein the electronics module comprises:
an amplifier, electrically coupled to the vibration module, configured to amplify a signal; and
a volume adjuster, coupled to the base module and disposed adjacent thereto, configured to enable the musician to adjust a volume of a transducer from the group of transducers consisting of the vibratory transducer and audio transducer without breaking physical contact with the base module.

4. The monitoring platform of claim 1, wherein the base comprises:
first and second clamshell members each hingedly coupled to the other; and
a handle coupled to the first clamshell member.

5. (canceled)

6. The monitoring platform of claim 1, further comprising:
a headset configured to receive a third signal from the electronics module; and
a headset volume adjuster.

7. The monitoring platform of claim 1, wherein the base comprises:
a ramping member including a first edge defining an exterior edge of the monitoring platform;
an upper surface member substantially planar and substantially orthogonal to a direction of gravity when in use; and
a storage member coextensive with the upper surface member, extending higher than the upper surface member, and enclosing the electronics module.

8. The monitoring platform of claim 7, further comprising:
a reflective coating disposed on the ramping member;
first and second clamshell members each hingedly coupled to the other;
a handle coupled to the first clamshell member;
a coupling member disposed on at least one of the first and second clamshell members and configured to couple the first and second clamshell members when the monitoring platform is in a storage mode;
a vent through at least one of the first and second clamshell members; and
an electrical outlet electrically coupled to the electronics module and accessible to a user when the monitoring platform is in a deployed mode.

9. The monitoring platform of claim 4, further comprising:
an upper surface member having a top surface substantially planar and substantially orthogonal to a direction of gravity when in use; and
a storage member disposed on the top surface of the upper surface member and enclosing the electronics module.

10. A system for providing a sensory feed to a musician, comprising:
a base module; and
a vibratory transducer module coupled to the base module, wherein the vibratory transducer module produces a vibratory signal through the base module between about 20 Hz to about 800 Hz; and
an audio transducer module coupled to the base module, wherein the audio transducer module produces an audible vibratory signal.

11. The system of claim 10, wherein the base module includes a plurality of support ridges.

12. The system of claim 10, further including an amplifier, electrically coupled to the vibratory transducer module, configured to amplify a signal.

13. The system of claim 10, further including a volume adjuster, coupled to the base module and disposed adjacent thereto, configured to enable the musician to adjust a volume of a transducer from the group of transducers consisting of the vibratory transducer and audio transducer without breaking physical contact with the base module.

14. The system of claim 10, wherein the base module includes a ramping member configured to facilitate a musician establishing physical contact with the base module.

15. The system of claim 10, further including an electrical outlet, coupled to the base module, configured to provide electrical power when coupled to another device.

16. The system of claim 10, further including a daisy-chain signal port, coupled to the base module, configured to enable signal communication to a second base module.

17. The system of claim 10, wherein the base module is removably coupleable to a second base module, wherein each of top surfaces of the base module and the second base module are substantially coplanar and coextensive.

18. (canceled)

19. The system of claim 10, further including a high pass filter coupled to the vibratory transducer module restricting vibrations lower than about 20 Hz.

20. A monitoring platform for providing a sensory feed to a musician, comprising:
a base, including:
a ramping member including a first edge defining an exterior edge of the monitoring platform;
an upper surface member substantially planar and substantially orthogonal to a direction of gravity when in use; and
a storage member coextensive with the upper surface member, extending higher than the upper surface member, and enclosing the electronics module;
first and second clamshell members each hingedly coupled to the other;
a handle coupled to the first clamshell member;
a coupling member disposed on at least one of the first and second clamshell members and configured to couple the first and second clamshell members when the monitoring platform is in a storage mode; and
a vent through at least one of the first and second clamshell members; and
an electronics module coupled to the base;
a reflective coating disposed on the ramping member;
an electrical outlet electrically coupled to the electronics module and accessible to a user when the monitoring platform is in a deployed mode; and
a tactile transducer in oscillatory communication with the base and in electrical communication with the electronics module.
